(19) United States
(12) Patent Application Publication
(10) Pub. No.: US 2025/0386249 A1
(43) Pub. Date: Dec. 18, 2025

(54) GROUP SCHEDULING AND/OR GROUP MESSAGE TRANSMISSION

(71) Applicant: APPLE INC., Cupertino, CA (US)

(72) Inventors: Fangli Xu, Beijing (CN); Peng Cheng, Beijing (CN); Haijing Hu, Los Gatos, CA (US); Yuqin Chen, Beijing (CN)

(21) Appl. No.: 19/107,705

(22) PCT Filed: Sep. 23, 2022
(86) PCT No.: PCT/CN2022/120861

§ 371 Date: Feb. 28, 2025

(51) Int. Cl. H04W 36/00

(52) U.S. Cl. CPC H04W 36/0009; H04W 36/00837

(57) ABSTRACT

The present disclosure relates to group scheduling and/or group message transmission. In an aspect, there is provided a wireless device, comprising: at least one antenna providing at least one spatial layer; at least one radio coupled to the at least one antenna; and a processor coupled to the at least one radio; wherein the processor is configured to receive, from a cellular base station via the at least one radio, a message comprising configuration related to at least one operation associated with a group of wireless devices comprising said wireless device, wherein said configuration at least indicating a start condition and a stop condition; and perform monitoring related to said at least one operation within a period during which the start condition is satisfied and the stop condition is not satisfied, wherein the monitoring is not performed if the start condition is not satisfied and/or the stop condition is satisfied.

### TECHNICAL FIELD

This application relates generally to wireless communication systems, including wireless device, cellular base station, methods, apparatus for group scheduling and/or group message transmission.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a or g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### SUMMARY

Embodiments relate to device, method, apparatus, computer-readable storage medium and computer program product for wireless communication.

According to an aspect, there is provided a wireless device, comprising: at least one antenna providing at least one spatial layer; at least one radio coupled to the at least one antenna; and a processor coupled to the at least one radio; wherein the processor is configured to receive, from a cellular base station via the at least one radio, a message comprising configuration related to at least one operation associated with a group of wireless devices comprising said wireless device, wherein said configuration at least indicating a start condition and a stop condition; and perform monitoring related to said at least one operation within a period during which the start condition is satisfied and the stop condition is not satisfied, wherein the monitoring is not performed if the start condition is not satisfied and/or the stop condition is satisfied.

According to another aspect, there is provided a cellular base station, comprising: at least one antenna; at least one radio coupled to the at least one antenna; and a processor coupled to the at least one radio; wherein the processor is configured to: transmit, to a wireless device via the at least one radio, a message comprising configuration related to at least one operation associated with a group of wireless devices comprising said wireless device, wherein said configuration at least indicating a start condition and a stop condition, wherein the message causes the wireless device to perform monitoring related to said at least one operation within a period during which the start condition is satisfied and the stop condition is not satisfied, and not to perform the monitoring if the start condition is not satisfied and/or the stop condition is satisfied.

According to another aspect, there is provided a method for a wireless device, comprising: receiving, from a cellular base station, a message comprising configuration related to at least one operation associated with a group of wireless devices comprising said wireless device, wherein said configuration at least indicating a start condition and a stop condition; and performing monitoring related to said at least one operation within a period during which the start condition is satisfied and the stop condition is not satisfied, wherein the monitoring is not performed if the start condition is not satisfied and/or the stop condition is satisfied.

According to another aspect, there is provided a method for a cellular base station, comprising transmitting, to a wireless device, a message comprising configuration related to at least one operation associated with a group of wireless devices comprising said wireless device, wherein said configuration at least indicating a start condition and a stop condition, wherein the message causes the wireless device to perform monitoring related to said at least one operation within a period during which the start condition is satisfied and the stop condition is not satisfied, and not to perform the monitoring if the start condition is not satisfied and/or the stop condition is satisfied.

According to another aspect, there is provided an apparatus, comprising: a processor configured to cause a wireless device to: receive, from a cellular base station via the at least one radio, a message comprising configuration related to at least one operation associated with a group of wireless devices comprising said wireless device, wherein said configuration at least indicating a start condition and a stop condition; and perform monitoring related to said at least one operation within a period during which the start condition is satisfied and the stop condition is not satisfied, wherein the monitoring is not performed if the start condition is not satisfied and/or the stop condition is satisfied.

According to another aspect, there is provided computer-readable storage medium storing program instructions, wherein the program instructions, when executed by a computer system, cause the computer system to perform the method of any of the above aspects.

According to another aspect, there is provided a computer program product, comprising program instructions which, when executed by a computer, cause the computer to perform the method of any of the above aspects.

The techniques described herein may be implemented in and/or used with a number of different types of devices, including but not limited to cellular phones, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example architecture of a wireless communication system, according to embodiments disclosed herein.

FIG. 2 illustrates a system for performing signaling between a wireless device and a network device, according to embodiments disclosed herein.

FIG. 3 illustrates a general flow-chat according to embodiments disclosed herein.

FIG. 4a illustrates an example flow-chat according to the first embodiment of the present disclosure.

FIG. 4b illustrates an example flow-chat according to the first embodiment of the present disclosure.

FIG. 5a illustrates an example flow-chat according to the first implementation according to the second embodiment of the present disclosure.

FIG. 5b illustrates an example flow-chat according to the first implementation according to the second embodiment of the present disclosure.

FIG. 6a illustrates an example flow-chat according to the second implementation according to the second embodiment of the present disclosure.

FIG. 6b illustrates an example flow-chat according to the second implementation according to the second embodiment of the present disclosure.

FIG. 7 illustrates an example flow diagram for a wireless device according to the present disclosure.

FIG. 8 illustrates an example flow diagram for a network device according to the present disclosure.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

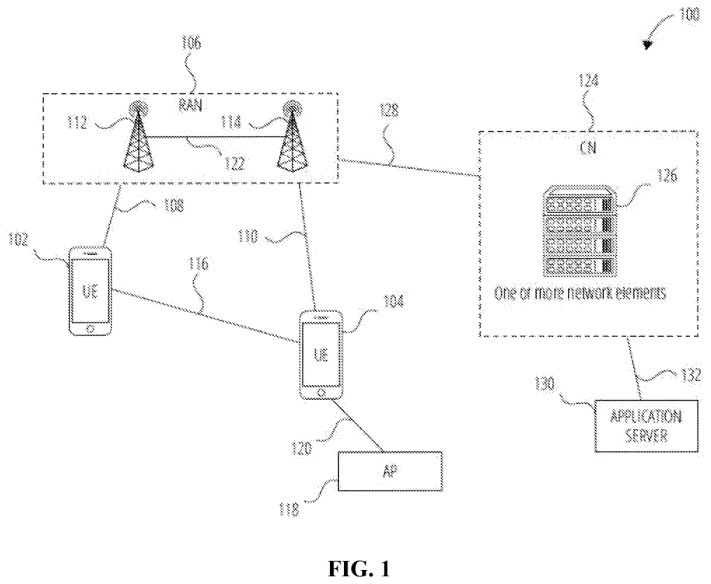

FIG. 1 illustrates an example architecture of a wireless communication system 100, according to embodiments disclosed herein. The following description is provided for an example wireless communication system 100 that operates in conjunction with the LTE system standards and/or 5G or NR system standards as provided by 3GPP technical specifications.

As shown by FIG. 1, the wireless communication system 100 includes UE 102 and UE 104 (although any number of UEs may be used). In this example, the UE 102 and the UE 104 are illustrated as smartphones (e.g., handheld touchscreen mobile computing devices connectable to one or more cellular networks), but may also comprise any mobile or non-mobile computing device configured for wireless communication.

The UE 102 and UE 104 may be configured to communicatively couple with a RAN 106. In embodiments, the RAN 106 may be NG-RAN, E-UTRAN, etc. The UE 102 and UE 104 utilize connections (or channels) (shown as connection 108 and connection 110, respectively) with the RAN 106, each of which comprises a physical communications interface. The RAN 106 can include one or more base stations, such as base station 112 and base station 114, that enable the connection 108 and connection 110.

In this example, the connection 108 and connection 110 are air interfaces to enable such communicative coupling, and may be consistent with RAT(s) used by the RAN 106, such as, for example, an LTE and/or NR.

In some embodiments, the UE 102 and UE 104 may also directly exchange communication data via a sidelink interface 116. The UE 104 is shown to be configured to access an access point (shown as AP 118) via connection 120. By way of example, the connection 120 can comprise a local wireless connection, such as a connection consistent with any IEEE 802.11 protocol, wherein the AP 118 may comprise a Wi-Fi® router. In this example, the AP 118 may be connected to another network (for example, the Internet) without going through a CN 124.

In embodiments, the UE 102 and UE 104 can be configured to communicate using orthogonal frequency division multiplexing (OFDM) communication signals with each other or with the base station 112 and/or the base station 114 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 112 or base station 114 may be implemented as one or more software entities running on server computers as part of a virtual network. In addition, or in other embodiments, the base station 112 or base station 114 may be configured to communicate with one another via interface 122. In embodiments where the wireless communication system 100 is an LTE system (e.g., when the CN 124 is an EPC), the interface 122 may be an X2 interface. The X2 interface may be defined between two or more base stations (e.g., two or more eNBs and the like) that connect to an EPC, and/or between two eNBs connecting to the EPC. In embodiments where the wireless communication system 100 is an NR system (e.g., when CN 124 is a 5GC), the interface 122 may be an Xn interface. The Xn interface is defined between two or more base stations (e.g., two or more gNBs and the like) that connect to 5GC, between a base station 112 (e.g., a gNB) connecting to 5GC and an eNB, and/or between two eNBs connecting to 5GC (e.g., CN 124).

The RAN 106 is shown to be communicatively coupled to the CN 124. The CN 124 may comprise one or more network elements 126, which are configured to offer various data and telecommunications services to customers/subscribers (e.g., users of UE 102 and UE 104) who are connected to the CN 124 via the RAN 106. The components of the CN 124 may be implemented in one physical device or separate physical devices including components to read and execute instructions from a machine-readable or computer-readable medium (e.g., a non-transitory machine-readable storage medium).

In embodiments, the CN 124 may be an EPC, and the RAN 106 may be connected with the CN 124 via an S1 interface 128. In embodiments, the S1 interface 128 may be split into two parts, an S1 user plane (S1-U) interface, which carries traffic data between the base station 112 or base station 114 and a serving gateway (S-GW), and the S1-MME interface, which is a signaling interface between the base station 112 or base station 114 and mobility management entities (MMEs).

In embodiments, the CN 124 may be a 5GC, and the RAN 106 may be connected with the CN 124 via an NG interface 128. In embodiments, the NG interface 128 may be split into two parts, an NG user plane (NG-U) interface, which carries traffic data between the base station 112 or base station 114 and a user plane function (UPF), and the S1 control plane (NG-C) interface, which is a signaling interface between the base station 112 or base station 114 and access and mobility management functions (AMFs).

Generally, an application server 130 may be an element offering applications that use internet protocol (IP) bearer resources with the CN 124 (e.g., packet switched data services). The application server 130 can also be configured to support one or more communication services (e.g., VoIP sessions, group communication sessions, etc.) for the UE 102 and UE 104 via the CN 124. The application server 130 may communicate with the CN 124 through an IP communications interface 132.

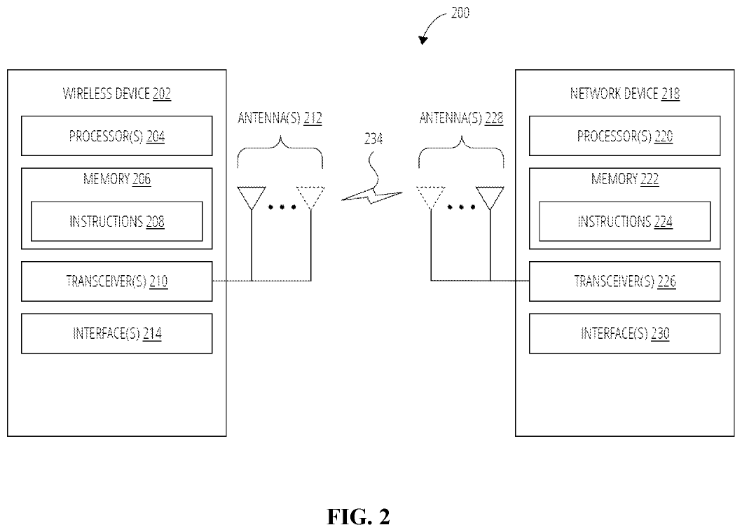

FIG. 2 illustrates a system 200 for performing signaling 234 between a wireless device 202 and a network device 218, according to embodiments disclosed herein. The system 200 may be a portion of a wireless communications system as herein described. The wireless device 202 may be, for example, a UE of a wireless communication system. The network device 218 may be, for example, a base station (e.g., an eNB or a gNB) of a wireless communication system.

The wireless device 202 may include one or more processor(s) 204. The processor(s) 204 may execute instructions such that various operations of the wireless device 202 are performed, as described herein. The processor(s) 204 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 202 may include a memory 206. The memory 206 may be a non-transitory computer-readable storage medium that stores instructions 208 (which may include, for example, the instructions being executed by the processor(s) 204). The instructions 208 may also be referred to as program code or a computer program. The memory 206 may also store data used by, and results computed by, the processor(s) 204.

The wireless device 202 may include one or more transceiver(s) 210 that may include radio frequency (RF) transmitter and/or receiver circuitry that use the antenna(s) 212 of the wireless device 202 to facilitate signaling (e.g., the signaling 234) to and/or from the wireless device 202 with other devices (e.g., the network device 218) according to corresponding RATs.

The wireless device 202 may include one or more antenna(s) 212 (e.g., one, two, four, or more). For embodiments with multiple antenna(s) 212, the wireless device 202 may leverage the spatial diversity of such multiple antenna(s) 212 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 202 may be accomplished according to precoding (or digital beamforming) that is applied at the wireless device 202 that multiplexes the data streams across the antenna(s) 212 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 202 may implement analog beamforming techniques, whereby phases of the signals sent by the antenna(s) 212 are relatively adjusted such that the (joint) transmission of the antenna(s) 212 can be directed (this is sometimes referred to as beam steering).

The wireless device 202 may include one or more interface(s) 214. The interface(s) 214 may be used to provide input to or output from the wireless device 202. For example, a wireless device 202 that is a UE may include interface(s) 214 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 210/antenna(s) 212 already described) that allow for communication between the UE and other devices and may operate according to known protocols (e.g., Wi-Fi®, Bluetooth®, and the like).

The network device 218 may include one or more processor(s) 220. The processor(s) 220 may execute instructions such that various operations of the network device 218 are performed, as described herein. The processor(s) 204 may include one or more baseband processors implemented using, for example, a CPU, a DSP, an ASIC, a controller, an FPGA device, another hardware device, a firmware device, or any combination thereof configured to perform the operations described herein.

The network device 218 may include a memory 222. The memory 222 may be a non-transitory computer-readable storage medium that stores instructions 224 (which may include, for example, the instructions being executed by the processor(s) 220). The instructions 224 may also be referred to as program code or a computer program. The memory 222 may also store data used by, and results computed by, the processor(s) 220.

The network device 218 may include one or more transceiver(s) 226 that may include RF transmitter and/or receiver circuitry that use the antenna(s) 228 of the network device 218 to facilitate signaling (e.g., the signaling 234) to and/or from the network device 218 with other devices (e.g., the wireless device 202) according to corresponding RATs.

The network device 218 may include one or more antenna(s) 228 (e.g., one, two, four, or more). In embodiments having multiple antenna(s) 228, the network device 218 may perform MIMO, digital beamforming, analog beamforming, beam steering, etc., as has been described.

The network device 218 may include one or more interface(s) 230. The interface(s) 230 may be used to provide input to or output from the network device 218. For example, a network device 218 that is a base station may include interface(s) 230 made up of transmitters, receivers, and other circuitry (e.g., other than the transceiver(s) 226/antenna(s) 228 already described) that enables the base station to communicate with other equipment in a core network, and/or that enables the base station to communicate with external networks, computers, databases, and the like for purposes of operations, administration, and maintenance of the base station or other equipment operably connected thereto.

The following description will take 5G NR as an example to illustrate the concept of the present disclosure, but it should be understood that the solution of the present disclosure is applicable to any appropriate mobile communication technology (e.g. 6G or any applicable advanced mobile communication technology).

In the following description, gNB is sometimes used to represent the control device at the base station side in a wireless communication network. It should be understood this is for illustrative purpose only but not restrictive. A base station based on any appropriate mobile communication technology is applicable. Besides, the operations performed by the gNB is sometimes described as the operations performed by the network or at the network side.

With the development of mobile communication technology and diversity of application scenarios, group scheduling/transmission can be used by the network (e.g. a gBN). For example, the group scheduling/transmission may refer to the network scheduling a group of UEs to perform an operation or a series of operations following a command broadcasted/groupcasted from the network and/or when one or more conditions are fulfilled. For example, the network can broadcast or groupcast a command to the group of UEs, and the UEs may perform the operation(s) once the command has been received. For another example, the network can configure some condition(s) for each of the group of UEs. Once the condition(s) has been fulfilled, e.g. when a certain time is arrived, when the UE enters into a certain zone, when the channel condition satisfies some threshold, or when a certain event is happened etc., the UEs may perform the operation(s). For another example, the NW can trigger the group of UEs to perform the operation(s) by combining the command with the condition(s). With the group scheduling/transmission, the network can efficiently manage different groups of UEs and can reduce signaling overhead, for example.

However, if the UE keep monitoring to determine if such a command is received and/or such condition(s) is fulfilled, the power consumption may be huge. Therefore, there is a need to provide a solution enables group scheduling/transmission without incurring too much power consumption at the UE side.

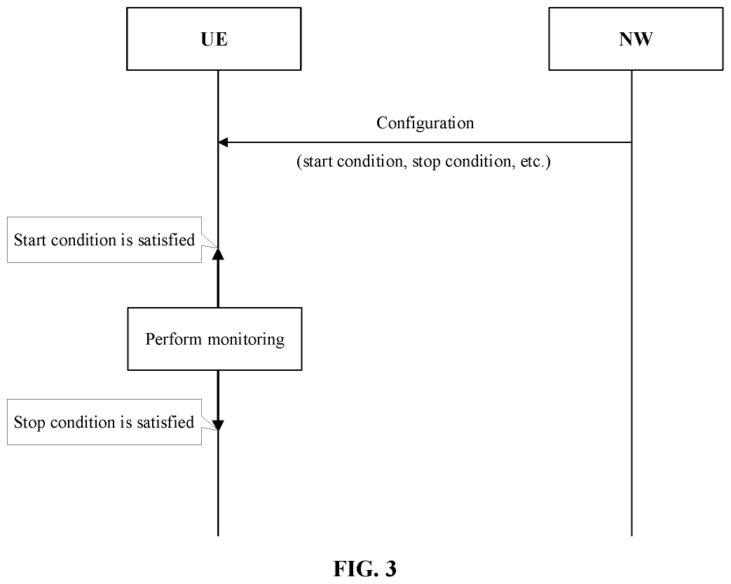

FIG. 3 illustrates a general flow-chat according to embodiments disclosed herein.

As shown in FIG. 3, according to the present disclosure, the group scheduling/transmission can be performed under some conditions configured by the network (NW). Particularly, the UE may receive, from the NW, a message comprising configuration related to at least one operation associated with a group of UEs comprising the UE. Such a configuration may at least indicate a start condition and a stop condition. The UE may perform monitoring related to the at least one operation within a period during which the start condition is satisfied and the stop condition is not satisfied, and particularly, the monitoring is not performed if the start condition is not satisfied and/or the stop condition is satisfied. In other words, the NW can configure the condition(s) under which the group scheduling/transmission is to be performed by transmitting a message to the UE. Such a message can be UE specific. For example, such a message can be a Radio Resource Control (RRC) Reconfiguration message. Alternatively, if the same condition(s) can be share by all or some UEs of the group of UEs, such a message can be broadcasted or groupcasted to those UE. When the configured conditions are fulfilled (e.g. the start condition is satisfied and the stop condition is not satisfied), the UE can perform monitoring so as to prepare to perform the at least one operation.

According to the present disclosure, the start condition can be any one or any combination of a time-based condition, a location-based condition, a radio quality-based condition, and an event-based condition. For example, the time-based condition can indicate that the UE can start to perform the monitoring only when a particular time is arrived. For example, such a particular time can be an absolute time (e.g. UTC time) or a relative time (e.g. after a certain period since receiving the above described message comprising the configuration). For example, the location-based condition can indicate that the UE can start to perform the monitoring only when it enters a particular zone. For example, such a particular zone can be defined as a relative distance to a reference location (e.g. the center of a cell, a Global Navigation Satellite System (GNSS) position, etc.) or as an absolute geographic zone (e.g. represent by GNSS coordinates). For example, the radio quality-based condition can indicate that the UE can start to perform the monitoring only when the radio quality or the channel status becomes higher or lower than a predetermined level (e.g. current Reference Signal Receiving Power (RSRP) becomes higher or lower than a predetermined threshold). For example, the event-based condition can indicate that the UE can start to perform the monitoring only when a particular event is occurred (e.g. a particular instruction is received or a particular condition is met).

According to the present disclosure, the stop condition can be any one or any combination of a time-based condition, a duration-based condition, a location-based condition, a radio quality-based condition, and an event-based condition. For example, the time-based condition can indicate that the UE may stop performing the monitoring once a particular time has arrived. For example, such a particular time can be an absolute time (e.g. UTC time) or a relative time (e.g. after a certain period since receiving the above described message comprising the configuration). For example, the duration-based condition can indicate that the UE may stop performing the monitoring once the duration has been reached (e.g. a certain period has passed since the monitoring has started). For example, the location-based condition can indicate that the UE may stop performing the monitoring once it has entered/or left a particular zone. For example, such a particular zone can be defined as a relative distance to a reference location (e.g. the center of a cell, a GNSS position, etc.) or as an absolute geographic zone (e.g. represent by GNSS coordinates). For example, the radio quality-based condition can indicate that the UE may stop performing the monitoring once the radio quality or the channel status has become higher or lower than a predetermined level (e.g. current RSRP becomes higher or lower than a predetermined threshold). For example, the event-based condition can indicate that the UE may start to perform the monitoring only when a particular event is occurred (e.g. a particular instruction is received or a particular condition is met).

In addition to the start condition and the stop condition, the configuration comprised in the message can indicate any other configuration necessary for the UE to perform the at least one operation. For example, the configuration can indicate the specific channel/signaling/resource on which the command to trigger the operation(s) will be transmitted, so that the UE is able to understand which channel/signaling/resource shall be monitored. For another example, the configuration can indicate one or more conditions for performing the operation(s), such that the UE is able to understand only when the one or more conditions are satisfied, the operation(s) can be performed. For example, such condition(s) triggering the performing of the operation(s) can comprise any one or more of:
an event, (e.g. the UE can perform the operation(s) only when the measurements show that the channel status becomes better or worse than a threshold),
a time-based trigger condition (e.g. the UE can perform the operation(s) only during a certain period of time, or a particular timing is arrived), and
a location-based trigger condition (e.g. the UE can perform the operation(s) only when it is located in a particular zone).

According to the present disclosure, the UE can perform the monitoring once the start condition has been satisfied. For example, the UE can start to monitor for a command and/or a condition which triggers performing of the at least one operation associated with a group of UEs once the start condition is satisfied. Particularly, in the case that the operation(s) comprises receiving at least one message broadcasted or groupcasted to the group of UEs, the UE can start to monitor one or more channel or signaling for the at least one message once the start condition has been satisfied.

The general concept of the present disclosure has been described above. Such a concept can be used for any group scheduling and/or group message transmission. Under such group scheduling and/or group message transmission, a group of UEs can be scheduled to perform one or a series of operations and/or the group of UEs can receive one or more messages addressed to the group, according to any suitable scenarios. The following will take group handover as an example operation under the group scheduling to further illustrates the present concept. However, the operation(s) under the group scheduling is not limited to group handover and can comprise any suitable operations such as message transmission, state change/transition, etc.

For example, under the group handover, a group of UEs may perform handover in response to a command broadcasted or groupcasted to the group being received, and/or some condition(s) being satisfied. Typically, under the group handover, the handover performed by each UE is not triggered by a UE specific command. Under the present context, the group handover means the group of UEs may need to perform handover based on a common command and/or similar condition(s), but the group handover does not necessarily require the group of UEs to perform handover strictly simultaneously and does not necessarily require the group of UEs to handover to a same cell. Herein, for an individual UE, the expression “performing group handover” means to handover to a cell suitable to that UE when the broadcasted or groupcasted command is received and/or the condition(s) is satisfied.

A typical scenario for scheduling group handover is the Non-Terrestrial Networks (NTN) scenario. NTN refers to networks or segments of networks using airborne vehicle(s), such as High Altitude Platform (HAPS)), or spaceborne vehicle(s), such as Low Earth Orbit (LEO), Middle Earth Orbit (MEO), Geostationary/Geosynchronous Earth Orbit (GEO), High Elliptical Orbit (HEO) satellite(s) for transmission. NTN is typically used to address mobile broadband needs and public safety needs in unserved/underserved areas, such as maritime, railway and airplane connectivity, etc. In NTN, the coverage of a cell or a beam is typically much larger than the cell in the terrestrial networks. For example, the coverage of on NTN cell may be across multiple countries.

Under NTN, the satellite may move with respect to the earth. Therefore, the cell may move together with the satellite. Besides, the Gateway or gNB to which the satellite is connected may change as the movement of the satellite. Accordingly, the feeder link (i.e. the link between the satellite and the Gateway or gNB) may switch as the movement of the satellite. Therefore, under the NTN specific scenarios, all the UEs in a same geographic area or served by a same satellite may need to perform handover due to the satellite change caused by the satellite movement or the cell information change caused by the feeder link change. Considering the large cell size of non-terrestrial networks, many devices may be served within a single cell. Depending on constellation assumptions (e.g. propagation delay and satellite speed) and UE density, a potentially very large number of UEs may need to perform handover at a given time, leading to possibly large signaling overhead and service continuity challenges. In view of this, group handover can be a solution, for example to reduce signaling.

Another typical scenario for scheduling group handover is the moving cell specific scenario. Under such a scenario, as the movement of the cell, all the UEs in a same geographic area or served by a same moving cell may need to perform handover due to the cell change.

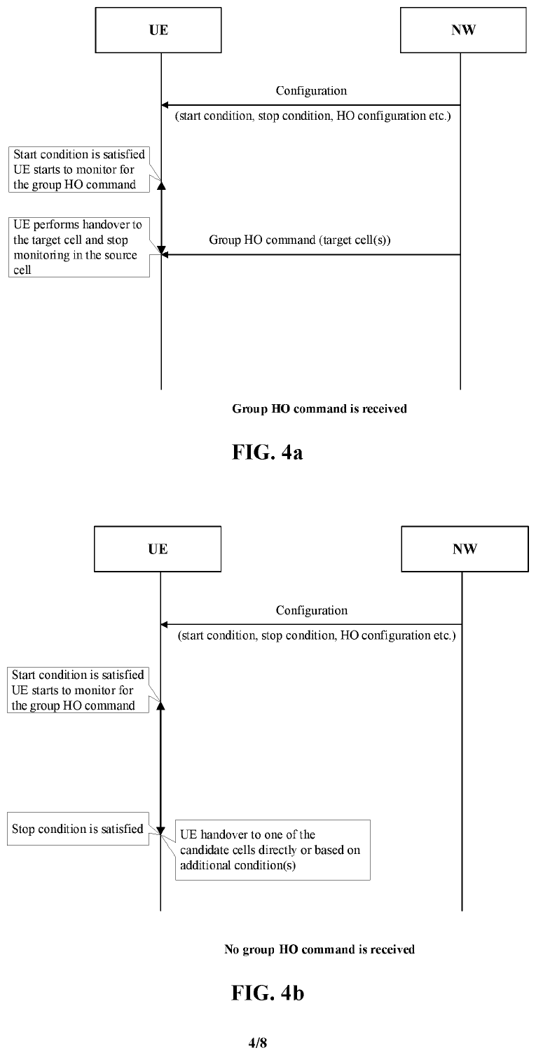

According to the first embodiment of the present disclosure, the group handover can be triggered by a group handover command broadcasted or groupcasted to a group of UEs. FIG. 4a illustrates an example flow-chat according to the first embodiment of the present disclosure.

As shown in FIG. 4a, the UE may receive, from the NW, a message comprising configuration related to group handover associated with a group of UEs comprising the UE. For example, such a configuration may indicate a start condition, a stop condition, handover configuration, and any other information necessary for the UE to perform monitoring and/or handover. As described above, the start condition can by any one or any combination of a time-based condition, a location-based condition, a radio quality-based condition, and an event-based condition. The stop condition can be any one or any combination of a time-based condition, a duration-based condition, a location-based condition, a radio quality-based condition, and an event-based condition. The handover configuration, for example, can at least indicate one or more candidate cells for the UE to perform handover and some information for the UE to monitor for the group handover command. For example, such information may comprise on which channel/signaling/resource and/or at which timing the UE shall perform monitoring so as to receive the group handover command. Particularly, the NW can provide such a message via an RRC Reconfiguration.

Once the start condition has been satisfied, the UE can start to monitor for the group handover command broadcasted or groupcasted to its group. For example, UE can use the information provided by the previously received message to perform monitoring. For example, the UE can perform monitoring on a specific channel/resource or monitor for a specific signaling. For example, the group handover command can be transmitted via L1/L2/L3 signaling.

During the monitoring window (i.e. in the period during which the start condition is satisfied and the stop condition is not satisfied), the UE can perform handover once the group handover command has been received. For example, the group handover command can explicitly indicate one target cell for the group of UEs to handover to that cell. In this case, the UE can directly handover to the indicated target cell. For another example, the group handover command can indicate multiple candidate cells. In this case, the UE can handover to one of the multiple candidate cells indicated by the group handover command based on one or more factors. For example, the UE can select the best/suitable cell (e.g. the cell with the best channel quality) to perform the handover. In the case that the group handover command does not explicitly indicate any target cell to perform the handover, the UE can handover to one of the candidate cells indicated in the received configuration. For example, the UE can select a cell based on channels conditions to handover to.

For example, the UE can stop monitoring in the source/original cell once the group handover command has been received or once the handover has been accomplished.

It is possible that no group handover command is received within the monitoring window. FIG. 4b illustrates an example flow-chat under such a special case.

As shown in FIG. 4b, in response to the stop condition being satisfied and no group handover command being received within the monitoring window, the UE can handover to one of the candidate cells indicated by the configuration related to group handover. For example, the UE can perform handover directly. For another example, the UE can perform handover based on one or more additional conditions (such as channels conditions and/or any other suitable conditions). For example, the UE can handover to the candidate cell only if the candidate cell is better than the source cell or better than a predetermined threshold based on measurements performed by the UE.

If the configuration configures multiple candidate cells, the UE can handover to a selected cell. For example, the selected cell can be defined in advance (e.g. defined in the related standard) or provided in advance (via the previous configuration). For another example, the selection can be configured/notified by the NW in advance. For another example, the selection can be made by the UE itself based on one or more factors. For example, the UE can select the best/suitable cell (e.g. the cell with the best channel quality) to perform the handover.

The detailed operations of the UE according to the first embodiment of the present disclosure have been described with reference to FIG. 4a and FIG. 4b. Note that the flow chats shown in FIG. 4a and FIG. 4b are merely for illustration purpose without limitation. For example, some additional operations can be performed. For example, once the UE has accomplished the configuration related to the group handover provided by the NW, the UE can transmit a message back to the NW to notify that the configuration is complete. For example, in the case the message transmitted from the NW is an RRC Reconfiguration message, the UE can transmit an RRC Reconfiguration Complete message back to the NW. For another example, once the UE has accomplished the handover, the UE can transmit a message to the NW to notify that the handover is complete in the target cell.

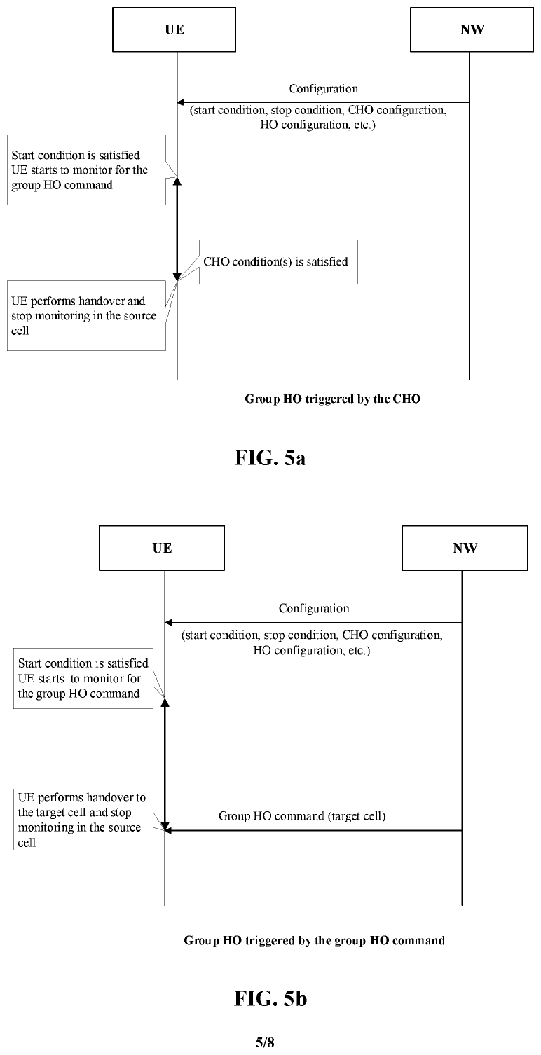

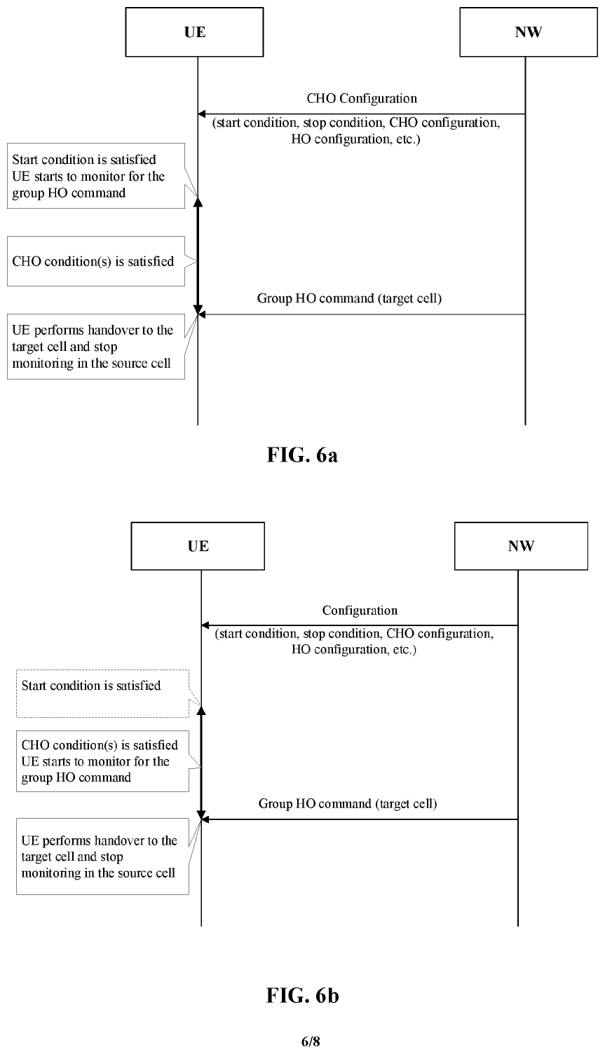

According to the second embodiment of the present disclosure, conditional handover (CHO) can be involved to perform the group handover. Different from normal handover, CHO can be triggered once some preconfigured condition(s) has been satisfied. Under the case of CHO, the UE can determine if the preconfigured condition(s) is satisfied by itself and perform CHO once the condition(s) has been satisfied without waiting for any handover command/instruction from the NW. According to the second embodiment of the present disclosure, CHO can be used in combination with the handover command to trigger the UE to perform group handover. FIG. 5a-6b illustrates example flow chats according to the second embodiment.

As shown in FIG. 5a-6b, the UE may receive, from the NW, a message comprising configuration related to group handover associated with a group of UEs comprising the UE. For example, such a configuration may indicate a start condition, a stop condition, CHO configuration, handover configuration and any other information necessary for the UE to perform monitoring and/or handover. For example, the NW can provide such a message via an RRC Reconfiguration.

Similar to those describe in the first embodiment, the start condition can by any one or any combination of a time-based condition, a location-based condition, a radio quality-based condition, and an event-based condition. The stop condition can be any one or any combination of a time-based condition, a duration-based condition, a location-based condition, a radio quality-based condition, and an event-based condition. The handover configuration, for example, can indicate some information for the UE to monitor for the group handover command. For example, such information may comprise on which channel/signaling/resource and/or at which timing the UE shall perform monitoring so as to receive the group handover command.

The CHO configuration can at least indicate one or more candidate cells for the group handover and at least one CHO condition so as to let the UE to perform the group handover once the at least one CHO condition has been satisfied. For example, the CHO condition can comprise any one or more of a measurement event, a time-based trigger condition, a location-based trigger condition, and other suitable conditions to trigger the handover. For example, the measurement event may indicate the UE to perform handover when the measurements show that the channel status of one of candidate cells becomes better than a threshold. For example, the time-based trigger condition may indicate the UE to perform CHO only during a certain period of time (e.g. between T1 and T2 where T1 and T2 are configured by the NW using UTC time, or a duration of time since a particular time or timing). For example, the location-based trigger condition may indicate the UE to perform CHO when the following conditions are fulfilled: (a) the distance between the UE and a first reference location is larger than a predetermined reference (e.g. away from the center of the source cell) and (b) the distance between the UE and a second reference location is smaller than a predetermined reference (e.g. approach to the center of a candidate cell). For example, any two or more of the measurement event, the time-based trigger condition, the location-based trigger condition, and other suitable conditions can be combined as a composite condition to trigger the handover.

Note that the UE can verify if the at least one CHO condition is satisfied at any suitable time since the CHO condition(s) has been configured, e.g. with a regular interval. For example, the verification of the CHO condition(s) can be irrelated to the start/stop condition. For example, the UE can verify the CHO condition(s) before the start condition being satisfied. For another example, according to the configuration/negotiation between the NW and the UE in advance or according to some default setting, the verification of the CHO condition(s) can also be controlled by the start/stop condition. For example, the UE can start to verify the CHO condition(s) once the start condition has been satisfied, and the UE cannot verify the CHO condition(s) when the stop condition is satisfied.

FIG. 5a-5b illustrate example flow chats according to the first implementation of the second embodiment. Under the first implementation, either the CHO or the group handover command can trigger the UE to perform the handover. In other words, the UE can perform the group handover once either (a) the group handover command has been received or (b) the at least one CHO condition has been satisfied.

For example, as illustrates in FIG. 5a, the UE can start to monitor for the group handover command once the start condition has been satisfied. While monitoring for the group handover command, the UE can verify if the at least one CHO condition is satisfied. Once the at least one CHO condition has been satisfied, the UE can perform group handover to one cell (e.g. similarly as described above, can be a selected cell or a predefined/preconfigured cell) of the candidate cells even if no handover command is received. For example, the UE can stop monitoring in the source/original cell once the at least one CHO condition has been satisfied or once the handover has been accomplished.

For example, as illustrates in FIG. 5b, the UE can start to monitor for the group handover command once the start condition has been satisfied. While monitoring for the group handover command, the UE can verify if the at least one CHO condition is satisfied. Once the handover command has been received, the UE can perform group handover (e.g. as described above, to a target cell indicated in the handover command, or to a predefined/preconfigured or a selected cell among the configured candidate cells). For example, the UE can stop monitoring in the source/original cell once the group handover command has been received or once the handover has been accomplished.

It is possible that (a) the group handover command being received and (b) the at least one CHO condition being satisfied are simultaneously fulfilled. In this case, the UE can perform the handover according to either of the group handover command or the CHO configuration. The UE can handover to a target cell indicated in the group handover command or handover to a candidate cell configured in the CHO configuration. Alternatively, the UE can perform the group handover according to a selected one of the group handover command and the CHO configuration. Such selection can be made based on a predetermined or preconfigured priority between the group handover command and the CHO configuration. For example, the UE can make the selection based on rules defined in the related standard (for example, the rule can define that the group handover command has a higher priority than the CHO configuration). For another example, the NW can configure the priority for the UE in advance.

According to the first implementation of the second embodiment, if no group handover command is received and the CHO condition(s) is not satisfied until the measuring window is closed, the UE, for example, can continue verifying the CHO condition(s) and perform the handover once the CHO condition(s) has been satisfied even though the stop condition is satisfied, alternatively, the UE can wait for the next message indicating the measuring window to verify the CHO condition(s) and measure for the group handover command.

FIG. 6a-6b illustrate example flow chats according to the second implementation of the second embodiment. Under the second implementation, both the satisfaction of the CHO condition(s) and the reception of the group handover command are necessary for triggering the UE to perform the handover. In other words, the UE can perform the group handover in response to both of the following are fulfilled: (a) the group handover command being received and (b) the at least one CHO condition being satisfied.

For example, the UE can start to monitor for the group handover command once the start condition has been satisfied. While monitoring for the group handover command, the UE can verify if the at least one CHO condition is satisfied. For example, the at least one CHO condition can be satisfied before the group handover command being received. In this case, as illustrated in FIG. 6a, the UE can continue monitoring for the group handover command within the monitoring window and perform group handover once the group handover command has been received. For example, the UE can stop monitoring in the source/original cell once the handover has been accomplished. For another example, the group handover command can be received before the CHO condition(s) being satisfied. In this case, the UE can continue verifying the CHO condition(s) and perform group handover once the CHO condition(s) has been satisfied. Particularly, if the group handover command has been received within the monitoring window but the CHO condition(s) has not yet been satisfied when the stop condition is satisfied, the UE can for example continue verifying the CHO condition(s) and perform group handover once the CHO condition(s) has been satisfied even though it is not in the monitoring window.

FIG. 6b illustrates another example flow chats according to the second implementation of the second embodiment. As can be seen from FIG. 6b, different from the operation flow shown in FIG. 6a, instead of starting to monitor for the group handover command once the start condition has been satisfied, the UE can start to monitor once the at least one CHO condition has been satisfied, such that the power consumption can be further reduced. For example, the NW can set the start condition in the configuration as an event-based condition so as to indicate that the start condition for monitoring for the handover command is the CHO condition(s) being met. For another example, the start condition can be configured in a same way as in other embodiments/implementations explained above, but the NW can further notify the UE to wait for the satisfaction of the CHO condition(s) to start the monitoring for the handover command. As illustrated in FIG. 6b, the UE can perform the group handover according to the received group handover command once the command has been received.

If no group handover command is received until the stop condition is satisfied, the UE can for example determine whether to perform the group handover according to the CHO configuration. For example, after the stop condition is satisfied, the UE can continue verify if the CHO condition(s) is satisfied and perform the group handover once the CHO condition(s) has been satisfied.

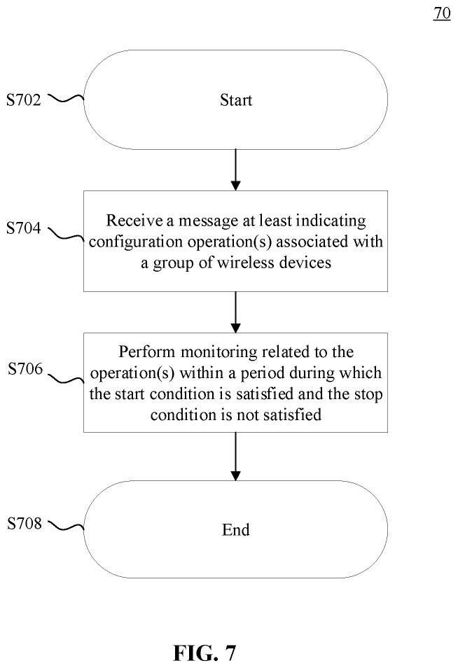

FIG. 7 is a flow diagram illustrating an example method 70 for group scheduling and/or group message transmission for a wireless device (e.g. a UE).

The method starts at S1702.

At S1704, the wireless device may receive, from a cellular base station, a message comprising configuration related to at least one operation associated with a group of wireless devices comprising the wireless device. Such configuration can at least indicate a start condition and a stop condition.

At S1706, the wireless device may perform monitoring related to the at least one operation within a period during which the start condition is satisfied and the stop condition is not satisfied. Particularly, the monitoring is not performed if the start condition is not satisfied and/or the stop condition is satisfied.

The method ends at S1708.

Note that the operations shown in FIG. 7 are only for the purpose of illustration without any limitation. The example implementation details of the operations have been described above. The operation flow of the wireless device can comprise any one or more additional operations as described above.

Embodiments contemplated herein include an apparatus comprising means to perform one or more elements of the method for group scheduling and/or group message transmission for a wireless device. This apparatus may be, for example, an apparatus of a UE (such as a wireless device 202 that is a UE, as described herein).

Embodiments contemplated herein include one or more non-transitory computer-readable media comprising instructions to cause an electronic device, upon execution of the instructions by one or more processors of the electronic device, to perform one or more elements of the method for group scheduling and/or group message transmission for a wireless device. This non-transitory computer-readable media may be, for example, a memory of a UE (such as a memory 206 of a wireless device 202 that is a UE, as described herein).

Embodiments contemplated herein include an apparatus comprising logic, modules, or circuitry to perform one or more elements of the method for group scheduling and/or group message transmission for a wireless device. This apparatus may be, for example, an apparatus of a UE (such as a wireless device 202 that is a UE, as described herein).

Embodiments contemplated herein include an apparatus comprising: one or more processors and one or more computer-readable media comprising instructions that, when executed by the one or more processors, cause the one or more processors to perform one or more elements of the method for group scheduling and/or group message transmission for a wireless device. This apparatus may be, for example, an apparatus of a UE (such as a wireless device 202 that is a UE, as described herein).

Embodiments contemplated herein include a signal as described in or related to one or more elements of the method for group scheduling and/or group message transmission for a wireless device.

Embodiments contemplated herein include a computer program or computer program product comprising instructions, wherein execution of the program by a processor is to cause the processor to carry out one or more elements of the method for group scheduling and/or group message transmission for a wireless device. The processor may be a processor of a UE (such as a processor(s) 204 of a wireless device 202 that is a UE, as described herein). These instructions may be, for example, located in the processor and/or on a memory of the UE (such as a memory 206 of a wireless device 202 that is a UE, as described herein).

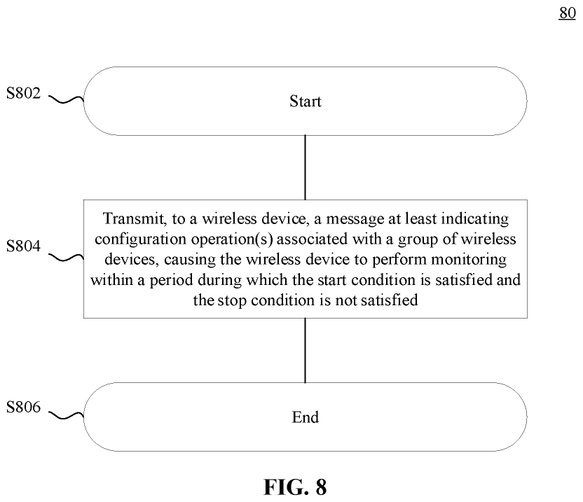

FIG. 8 is a flow diagram illustrating an example method 180 for group scheduling and/or group message transmission for a network device (e.g., a gNB).

The method starts at S802.

At S804, the network device may transmit, to a wireless device, a message comprising configuration related to at least one operation associated with a group of wireless devices comprising the wireless device. Such configuration at least indicating a start condition and a stop condition. The message may cause the wireless device to perform monitoring related to the at least one operation within a period during which the start condition is satisfied and the stop condition is not satisfied, and not to perform the monitoring if the start condition is not satisfied and/or the stop condition is satisfied.

The method ends at S806.

Note that the operations shown in FIG. 8 are only for the purpose of illustration without any limitation and can comprise one or more additional/supplementary operations. For example, before transmitting the message, the network device can enable the group scheduling and/or group message transmission related features, e.g. setup the group RRC Signaling Radio Bearer (SRB), enable the group mobility feature, etc. For another example, the network can receive a message indicating the handover is complete in a target cell from the wireless device.

Embodiments contemplated herein include an apparatus comprising means to perform one or more elements of the method for group scheduling and/or group message transmission for a network device. This apparatus may be, for example, an apparatus of a base station (such as a network device 218 that is a base station, as described herein).

Embodiments contemplated herein include one or more non-transitory computer-readable media comprising instructions to cause an electronic device, upon execution of the instructions by one or more processors of the electronic device, to perform one or more elements of the method for group scheduling and/or group message transmission for a network device. This non-transitory computer-readable media may be, for example, a memory of a base station (such as a memory 222 of a network device 218 that is a base station, as described herein).

Embodiments contemplated herein include an apparatus comprising logic, modules, or circuitry to perform one or more elements of the method for group scheduling and/or group message transmission for a network device. This apparatus may be, for example, an apparatus of a base station (such as a network device 218 that is a base station, as described herein).

Embodiments contemplated herein include an apparatus comprising: one or more processors and one or more computer-readable media comprising instructions that, when executed by the one or more processors, cause the one or more processors to perform one or more elements of the method for group scheduling and/or group message transmission for a network device. This apparatus may be, for example, an apparatus of a base station (such as a network device 218 that is a base station, as described herein).

Embodiments contemplated herein include a signal as described in or related to one or more elements of the method for group scheduling and/or group message transmission for a network device.

Embodiments contemplated herein include a computer program or computer program product comprising instructions, wherein execution of the program by a processing element is to cause the processing element to carry out one or more elements of the method for group scheduling and/or group message transmission for a network device. The processor may be a processor of a base station (such as a processor(s) 220 of a network device 218 that is a base station, as described herein). These instructions may be, for example, located in the processor and/or on a memory of the UE (such as a memory 222 of a network device 218 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

The above has described in detail group scheduling and/or group message transmission. With the present solution, advantageously, at least the signaling overhead can be reduced by performing the group scheduling/group message transmission, and the power consumption at the UE side can be reduced. In addition, the present disclosure can also have any of the configurations below.

(1) A wireless device, comprising:
at least one antenna providing at least one spatial layer;
at least one radio coupled to the at least one antenna; and
a processor coupled to the at least one radio;
wherein the processor is configured to
receive, from a cellular base station via the at least one radio, a message comprising configuration related to at least one operation associated with a group of wireless devices comprising said wireless device, wherein said configuration at least indicating a start condition and a stop condition; and
perform monitoring related to said at least one operation within a period during which the start condition is satisfied and the stop condition is not satisfied,
wherein the monitoring is not performed if the start condition is not satisfied and/or the stop condition is satisfied.

(2) The wireless device of (1), wherein the start condition comprises any one or more of:
a time-based condition;
a location-based condition;
a radio quality-based condition; and
an event-based condition.

(3) The wireless device of (1) or (2), wherein the stop condition comprises any one or more of:
a time-based condition;
a duration-based condition;
a location-based condition;
a radio quality-based condition; and
an event-based condition.

(4) The wireless device of (1) or (2), wherein performing the monitoring within the period where the start condition is satisfied and the stop condition is not satisfied further comprises starting to monitor for a command and/or a condition which triggers performing of said at least one operation once the start condition has been satisfied.

(5) The wireless device of (1) or (2), wherein the at least one operation comprises receiving at least one message broadcasted or groupcasted to said group of wireless devices, and performing the monitoring within the period where the start condition is satisfied and the stop condition is not satisfied further comprises starting to monitor one or more channel or signaling for said at least one message once the start condition has been satisfied.

(6) The wireless device of (1) or (2), wherein the at least one operation comprises performing group handover, said configuration further indicates HandOver (HO) configuration, wherein the HO configuration at least indicates one or more candidate cells for the group handover and information for monitoring for a group handover command.

(7) The wireless device of (6), wherein performing the monitoring within the period where the start condition is satisfied and the stop condition is not satisfied further comprises starting to monitor for the group handover command broadcasted or groupcasted to said group of wireless devices once the start condition has been satisfied, and
the processor is further configured to perform the group handover once the group handover command has been received.

(8) The wireless device of (7), wherein the processer is further configured to, in response to the stop condition being satisfied and no group handover command being received within said period:
in the case of said HO configuration indicating one candidate cell, handover to the indicated cell directly or determine whether to handover to the indicated cell based on one or more additional conditions;
in the case of said HO configuration indicating multiple candidate cells, handover to a selected cell directly or determine whether to handover to the selected cell based on one or more additional conditions, wherein the selected cell is predefined or preconfigured, or the selected cell is selected based on one or more factors.

(9) The wireless device of (1) or (2), wherein the at least one operation comprises performing group handover, said configuration further indicates Conditional HandOver (CHO) configuration and HandOver (HO) configuration, wherein the CHO configuration at least indicates one or more candidate cells for the group handover and at least one CHO condition, and the HO configuration at least indicates information for monitoring for a group handover command.

(10) The wireless device of (9), wherein the processor is further configured to verify if the at least one CHO condition is satisfied,
wherein performing the monitoring within the period where the start condition is satisfied and the stop condition is not satisfied further comprises: once the start condition has been satisfied, starting to perform monitoring for the group handover command broadcasted or groupcasted to said group of wireless devices, and
wherein the processor is further configured to perform the group handover once either (a) the group handover command has been received or (b) the at least one CHO condition has been satisfied.

(11) The wireless device of (10), wherein in the case of the (a) the group handover command being received and (b) the at least one CHO condition being satisfied are simultaneously fulfilled, the processor is further configured to perform the group handover according to either of the group handover command or the CHO configuration.

(12) The wireless device of (10), wherein in the case of the (a) the group handover command being received and (b) the at least one CHO condition being satisfied are simultaneously fulfilled, the processor is further configured to perform the group handover according to a selected one of the group handover command and the CHO configuration, wherein the selection is made based on a predetermined or preconfigured priority between the group handover command and the CHO configuration.

(13) The wireless device of (9), wherein the processor is further configured to verify if the at least one CHO condition is satisfied,
wherein performing the monitoring within the period where the start condition is satisfied and the stop condition is not satisfied further comprises once the start condition has been satisfied, starting to monitor for the group handover command broadcasted or groupcasted to said group of wireless devices, and
wherein the processor is further configured to perform the group handover in response to both (a) the group handover command being received and (b) the at least one CHO condition being satisfied being fulfilled.

(14) The wireless device of (9), wherein the processor is further configured to verify if the at least one CHO condition is satisfied, and
wherein performing the monitoring within the period where the start condition is satisfied and the stop condition is not satisfied further comprises starting to monitor for the group handover command once the at least one CHO condition has been satisfied, and
once the group handover command has been received, the processor is further configured to perform the group handover according to the handover command.

(15) The wireless device of (14), wherein no group handover command is not received within a period from the start of the monitoring until the stop condition is satisfied, the processor is further configured to determine whether to perform the group handover according to the CHO configuration.

(16) The wireless device of (9), wherein the CHO condition at least comprising any one or more of a measurement event, a time-based trigger condition, and a location-based trigger condition.

(17) The wireless device of (1), wherein the message is a Radio Resource Control (RRC) Reconfiguration message.

(18) A cellular base station, comprising:
at least one antenna;
at least one radio coupled to the at least one antenna; and
a processor coupled to the at least one radio;
wherein the processor is configured to:
transmit, to a wireless device via the at least one radio, a message comprising configuration related to at least one operation associated with a group of wireless devices comprising said wireless device, wherein said configuration at least indicating a start condition and a stop condition,
wherein the message causes the wireless device to perform monitoring related to said at least one operation within a period during which the start condition is satisfied and the stop condition is not satisfied, and not to perform the monitoring if the start condition is not satisfied and/or the stop condition is satisfied.

(19) A method for a wireless device, comprising:
receiving, from a cellular base station, a message comprising configuration related to at least one operation associated with a group of wireless devices comprising said wireless device, wherein said configuration at least indicating a start condition and a stop condition; and
performing monitoring related to said at least one operation within a period during which the start condition is satisfied and the stop condition is not satisfied,
wherein the monitoring is not performed if the start condition is not satisfied and/or the stop condition is satisfied.

(20) A method for a cellular base station, comprising
transmitting, to a wireless device, a message comprising configuration related to at least one operation associated with a group of wireless devices comprising said wireless device, wherein said configuration at least indicating a start condition and a stop condition,
wherein the message causes the wireless device to perform monitoring related to said at least one operation within a period during which the start condition is satisfied and the stop condition is not satisfied, and not to perform the monitoring if the start condition is not satisfied and/or the stop condition is satisfied.

(21) An apparatus, comprising:
a processor configured to cause a wireless device to:
   receive, from a cellular base station via the at least one radio, a message comprising configuration related to at least one operation associated with a group of wireless devices comprising said wireless device, wherein said configuration at least indicating a start condition and a stop condition; and
   perform monitoring related to said at least one operation within a period during which the start condition is satisfied and the stop condition is not satisfied,
   wherein the monitoring is not performed if the start condition is not satisfied and/or the stop condition is satisfied.

(22) A computer-readable storage medium storing program instructions, wherein the program instructions, when executed by a computer system, cause the computer system to perform the method of (19).

(23) A computer-readable storage medium storing program instructions, wherein the program instructions, when executed by a computer system, cause the computer system to perform the method of (20).

(24) A computer program product, comprising program instructions which, when executed by a computer, cause the computer to perform the method of (19).

(25) A computer program product, comprising program instructions which, when executed by a computer, cause the computer to perform the method of (20).

1. A wireless device, comprising:
at least one antenna providing at least one spatial layer;
at least one radio coupled to the at least one antenna; and
a processor coupled to the at least one radio;
wherein the processor is configured to
receive, from a cellular base station via the at least one radio, a message comprising configuration related to at least one operation associated with a group of wireless devices comprising said wireless device, wherein said configuration at least indicating a start condition and a stop condition; and
perform monitoring related to said at least one operation within a period during which the start condition is satisfied and the stop condition is not satisfied,
wherein the monitoring is not performed if the start condition is not satisfied and/or the stop condition is satisfied.

2. The wireless device of claim 1, wherein the start condition comprises any one or more of:
a time-based condition;
a location-based condition;
a radio quality-based condition; and
an event-based condition.

3. The wireless device of claim 1, wherein the stop condition comprises any one or more of:
a time-based condition;
a duration-based condition;
a location-based condition;
a radio quality-based condition; and
an event-based condition.

4. The wireless device of claim 1, wherein performing the monitoring within the period where the start condition is satisfied and the stop condition is not satisfied further comprises starting to monitor for a command and/or a condition which triggers performing of said at least one operation once the start condition has been satisfied.

5. The wireless device of claim 1, wherein the at least one operation comprises receiving at least one message broadcasted or groupcasted to said group of wireless devices, and performing the monitoring within the period where the start condition is satisfied and the stop condition is not satisfied further comprises starting to monitor one or more channel or signaling for said at least one message once the start condition has been satisfied.

6. The wireless device of claim 1, wherein the at least one operation comprises performing group handover, said configuration further indicates HandOver (HO) configuration, wherein the HO configuration at least indicates one or more candidate cells for the group handover and information for monitoring for a group handover command.

7. The wireless device of claim 6, wherein performing the monitoring within the period where the start condition is satisfied and the stop condition is not satisfied further comprises starting to monitor for the group handover command broadcasted or groupcasted to said group of wireless devices once the start condition has been satisfied, and
the processor is further configured to perform the group handover once the group handover command has been received.

8. The wireless device of claim 7, wherein the processer is further configured to, in response to the stop condition being satisfied and no group handover command being received within said period:
in the case of said HO configuration indicating one candidate cell, handover to the indicated cell directly or determine whether to handover to the indicated cell based on one or more additional conditions;
in the case of said HO configuration indicating multiple candidate cells, handover to a selected cell directly or determine whether to handover to the selected cell based on one or more additional conditions, wherein the selected cell is predefined or preconfigured, or the selected cell is selected based on one or more factors.

9. The wireless device of claim 1, wherein the at least one operation comprises performing group handover, said configuration further indicates Conditional HandOver (CHO) configuration and HandOver (HO) configuration, wherein the CHO configuration at least indicates one or more candidate cells for the group handover and at least one CHO condition, and the HO configuration at least indicates information for monitoring for a group handover command.

10. The wireless device of claim 9, wherein the processor is further configured to verify if the at least one CHO condition is satisfied,
wherein performing the monitoring within the period where the start condition is satisfied and the stop condition is not satisfied further comprises: once the start condition has been satisfied, starting to perform monitoring for the group handover command broadcasted or groupcasted to said group of wireless devices, and
wherein the processor is further configured to perform the group handover once either (a) the group handover command has been received or (b) the at least one CHO condition has been satisfied.

11. The wireless device of claim 10, wherein in the case of the (a) the group handover command being received and (b) the at least one CHO condition being satisfied are simultaneously fulfilled, the processor is further configured to perform the group handover according to either of the group handover command or the CHO configuration.

12. The wireless device of claim 10, wherein in the case of the (a) the group handover command being received and (b) the at least one CHO condition being satisfied are simultaneously fulfilled, the processor is further configured to perform the group handover according to a selected one of the group handover command and the CHO configuration, wherein the selection is made based on a predetermined or preconfigured priority between the group handover command and the CHO configuration.

13. The wireless device of claim 9, wherein the processor is further configured to verify if the at least one CHO condition is satisfied,
wherein performing the monitoring within the period where the start condition is satisfied and the stop condition is not satisfied further comprises once the start condition has been satisfied, starting to monitor for the group handover command broadcasted or groupcasted to said group of wireless devices, and
wherein the processor is further configured to perform the group handover in response to both (a) the group handover command being received and (b) the at least one CHO condition being satisfied being fulfilled.

14. The wireless device of claim 9, wherein the processor is further configured to verify if the at least one CHO condition is satisfied, and
wherein performing the monitoring within the period where the start condition is satisfied and the stop condition is not satisfied further comprises starting to monitor for the group handover command once the at least one CHO condition has been satisfied, and
once the group handover command has been received, the processor is further configured to perform the group handover according to the handover command.

15. The wireless device of claim 14, wherein no group handover command is not received within a period from the start of the monitoring until the stop condition is satisfied, the processor is further configured to determine whether to perform the group handover according to the CHO configuration.

16. The wireless device of claim 9, wherein the CHO condition at least comprising any one or more of a measurement event, a time-based trigger condition, and a location-based trigger condition.

17. The wireless device of claim 1, wherein the message is a Radio Resource Control (RRC) Reconfiguration message.

18. A cellular base station, comprising:
at least one antenna;
at least one radio coupled to the at least one antenna; and
a processor coupled to the at least one radio;
wherein the processor is configured to:
transmit, to a wireless device via the at least one radio, a message comprising configuration related to at least one operation associated with a group of wireless devices comprising said wireless device, wherein said configuration at least indicating a start condition and a stop condition,
wherein the message causes the wireless device to perform monitoring related to said at least one operation within a period during which the start condition is satisfied and the stop condition is not satisfied, and not to perform the monitoring if the start condition is not satisfied and/or the stop condition is satisfied.

19. A method for a wireless device, comprising:
receiving, from a cellular base station, a message comprising configuration related to at least one operation associated with a group of wireless devices comprising said wireless device, wherein said configuration at least indicating a start condition and a stop condition; and
performing monitoring related to said at least one operation within a period during which the start condition is satisfied and the stop condition is not satisfied,
wherein the monitoring is not performed if the start condition is not satisfied and/or the stop condition is satisfied.

20-25. (canceled)
